(19) United States
(12) Patent Application Publication
(10) Pub. No.: US 2009/0123206 A1
(43) Pub. Date: May 14, 2009

(54) MARKING SENSOR AND METHOD FOR EVALUATING MARKINGS

(76) Inventors: Holger Schnabel, Rottendorf (DE); Stephan Schultze, Lohr-Wombach (DE); Ulrich Dittmaier, Zellingen (DE)

Correspondence Address: STRIKER, STRIKER & STENBY, 103 EAST NECK ROAD, HUNTINGTON, NY, 11743, US

(21) Appl. No.: 12/252,762

(22) Filed: Oct. 16, 2008

(30) Foreign Application Priority Data
Oct. 17, 2007 (DE) 10 2007 049 679.8

(51) Int. Cl. B41J 11/44

(52) U.S. Cl. 400/76

(57) ABSTRACT

A marking sensor includes a detection unit for detecting markings on a processed material and for acquiring data based on the detected markings, at least one circuit output for outputting the acquired data, an evaluation unit for determining absolute output data on the detected markings based on the data acquired by the detection unit, and an interface for outputting the absolute output data; also a method is used for evaluating markings on a processed material that are detected by a detection unit, data are acquired based on the markings, and they may be output at least one circuit output and transferred to an evaluation unit in a marking sensor, in the evaluation unit, absolute output data on the detected markings are determined based on the data acquired by the detection unit, and the absolute output data on the detected markings is output at an interface of the marking sensor.

### CROSS-REFERENCE TO A RELATED APPLICATION

The invention described and claimed hereinbelow is also described in German Patent Application DE 10 2007 049 679.8 filed on Oct. 17, 2007. This German Patent Application, whose subject matter is incorporated here by reference, provides the basis for a claim of priority of invention under 35 U.S.C. 119(a)-(d).

### BACKGROUND OF THE INVENTION

The present invention relates to a marking sensor according to the preamble of Claim 1, and to a method for evaluating the markings.

Although the text below refers mainly to printing presses and their sensors, the present invention is not limited thereto, but rather is directed to all types of marking sensors and processing machines with which a processed material, e.g., in the form of separate material sections or a continuous material or a material web, is processed. The present invention is suited for use, in particular, with a register control for processing machines. The present invention may be used, in particular, with printing presses such as newspaper presses, jobbing presses, printing presses for packaging or currency, and processing machines such as bagging machines, envelope machines, or packaging machines. The processed material or the continuous material may be paper, cardboard, plastic, metal, rubber, or foil, etc.

With processing machines, in particular printing presses, material is moved and processed along driven and non-driven axles. “Register control” is carried out to orient the processing steps of consecutive processing devices with each other. To this end, markings, e.g., register marks, on the material are scanned by sensors, and the data acquired by the sensors is transmitted via a circuit output (usually 24V) to the higher-order system, i.e., a control device, an automation system, or a drive. For example, depending on the polarity of the sensor output, a positive edge of a register mark, i.e., the beginning of the register mark, is displayed at the circuit output as a falling or rising edge in the signal. The negative edge of the register mark, i.e., the end of the register mark, is displayed at the circuit output via the other edge.

The higher-order system to which the sensor is connected evaluates the edges. The results of this evaluation are combined with the information on the transport speed to determine the width and position of the register marks on the material. The disadvantage of the aforementioned solution is, e.g., that an additional dead-time compensation must be carried out, since the sensor requires a certain amount of processing time before the signal at the circuit output corresponds to the state of the register mark that was detected. A complex evaluation system is also required in the higher-order system in order to determine the absolute position values of the register marks based on the sensor data that was provided. Since a processing machine typically includes a large number of sensors of this type, the computing capacity of the control device must be sized accordingly so that the necessary computing time may be provided.

In addition, the markings to be detected, e.g., register marks, must be specified to the sensors manually during a “teaching” process, in which case the machine operator informs the particular sensor of the markings to be detected during a measuring run or using a separate sensor HMI, which requires a relatively great deal of time and results in waste.

In addition, it is not possible with conventional sensors to reconfigure them dynamically during the production phase, since the configuration may be changed only at a low “teach” speed or while a production change is being carried out.

### SUMMARY OF THE INVENTION

The present invention is therefore based on the object of providing an improved marking sensor and an improved method for evaluating markings, with which the disadvantages described above are overcome.

An inventive sensor includes a detection unit for detecting markings, in particular register marks, on a processed material, in particular a continuous material, and for acquiring data based on the markings that were detected. It also includes a circuit output for outputting acquired data, an evaluation unit for determining absolute output data of the detected markings based on the data acquired by the detection unit, and a preferably serial interface for outputting the output data to a control device. The inventive sensor includes a detection unit, of course, that may be, e.g., an optical sensor such as a color or contrast sensor, or a camera-based sensor, and an evaluation unit that, based on the acquired data, generates absolute output data related to the markings, in particular the distances between the markings and/or the dimensions of the markings themselves. The absolute output data that are generated are transferred via an interface—which is serial in particular and is preferably real-time capable—to a higher-order system, in particular a control device, an automation system, or a drive. In addition, the acquired data may be output via the circuit output.

With the inventive means of attaining the object of the present invention, absolute marking data, in particular the distance between register marks, are determined with high accuracy within the sensor itself in order to regulate the longitudinal register and/or the register mark widths in order to regulate the side register, and they may then be supplied directly to a control device, e.g., to perform register control. The evaluation of markings to be measured takes place directly in the sensor system, which provides significant relief to the higher-order control device or the higher-order drive. An external dead-time compensation may be eliminated.

The detection unit, i.e., the intelligent sensor, may be used on printing presses and processing machines, packaging machines, and web-processing machines. To this end, markings (e.g., register marks, preprinted material, etc.) that are detectable by the sensor and whose position may be measured must exist on the processed material. One or more processes may be synchronized based on the positions determined using the sensor. For example, register control may ensure that a printed image is exact. The circuit output, which is also present, for outputting acquired data makes it possible to also implement an inventive sensor in existing systems.

Advantageously, given that the inventive sensor is equipped with an evaluation unit, it is capable of performing several web-measuring procedures for the longitudinal register. With the “web/web” method, the sensor measures the distances between several markings and outputs the distance values. With the “web/cylinder” method, the sensor measures one or more markings. These data may be compared in the sensor with a supplied sensor signal, and the result of the comparison may be output via the interface. Likewise, the sensor may transmit the data described above via an optional circuit output to a drive, which may use this signal to determine the current position value of the axis with a high level of accuracy.

With the “top side/underside” method, a comparison of the front sides and back sides of register marks is carried out by coupling sensors. In this case, a sensor measures the markings on the front side and outputs—via an output (an interface or a circuit output)—the signal of the detected marking to the sensor on the back side of the material web. This sensor may now calculate the distance between the markings on the front and back sides and reply via the interface. Since the sensor is equipped with an evaluation unit, it is capable of performing all web-measuring procedures in parallel, or of switching between them on-line.

Via the interface, it is possible, e.g., to transfer a service-based protocol on a TCP and/or UDP basis using a service discovery at the beginning of the telegram data field. It is also possible to provide several commands within a telegram (e.g., initialization of several properties) or to transmit larger quantities of data (e.g., oscilloscope data) across all telegrams.

The interface is advantageously designed as an Ethernet interface, via which the sensor outputs the absolute output data, in particular for the side register and the longitudinal register. Any type of interface, in particular a serial interface, may be used, of course. In this manner, the inventive sensor may be easily incorporated into bus systems of processing machines. Via the Ethernet interface, it is possible, e.g., to configure the sensor, so that it may automatically (without the manual “teach” process) measure markings and deliver measured values. The teach process may take place dynamically in particular, in which case the sensor automatically searches—based on the configured data—the flow of markings (which typically have different colors) and calculates an “expectation window” in which the markings to be measured are located. The beginning of the marking flow may be characterized, in particular, by a configured bar code on the processed material, which the sensor may identify automatically.

As an alternative or in addition thereto, the necessary information may be supplied to the sensor via the interface. It is also possible to request diagnostic and/or oscilloscope data via the interface, and/or to define their resolution. These data may be made available to the operator so that he may visualize the flow of markings, and so that he may perform error diagnosis and/or take preventive action (e.g., contamination of the lens, a drop in color density). This makes it possible for the operator to intervene in a timely manner, and it prevents an interruption in the printing or processing procedure.

As an alternative or in addition to the Ethernet interface, the sensor may include a Profinet coupling, a SERCOS III coupling, an Ethernet-Powerlink coupling, an EtherCat coupling, an Ethernet/IP coupling, a Modbus-IDA coupling, a shared-RAM and/or DPRAM coupling. For example, a Sercos III connection may further improve communication, due to its real-time capability.

It is advantageous when the marking sensor includes a sensor input. It may serve, in particular, to transmit speed data to the sensor, based on which the sensor may determine the absolute data. It is also possible, of course, for the speed data to be transferred via the interface (e.g., with SERCOS III). It is preferable to couple the sensor input to sensor emulator outputs of a drive, control, and/or automation system.

Advantageously, one or more circuit outputs, in particular with 24V, are provided; which may be realized as single outputs, i.e., only one defined marking is output, or as collective outputs, i.e., several markings are output via the same circuit output, so that they thereby serve in particular to output the acquired data.

According to a preferred embodiment of the present invention, at least one input is provided for connecting further detection units. These detection units may be, in particular, sensors known from the related art, since they do not include their own evaluation units. In this manner, it is made possible to couple one or more detection units to an evaluation unit of the sensor and to thereby make the computing performance of the evaluation unit available for several detection units in one multiplex procedure. In this manner as well, it is possible to use existing sensors, i.e., pure detection units, with the inventive sensors together in a related processing machine.

Further advantages and embodiments of the present invention result from the description and the attached drawing.

It is understood that the features mentioned above and to be described below can be used not only in the combination described, but also in other combinations or alone without leaving the framework of the present invention.

The present invention is depicted schematically with reference to an exemplary embodiment in the drawing, and it is described in detail below with reference to the drawing.

### BRIEF DESCRIPTION OF THE DRAWINGS

FIG. 1 is a schematic depiction of a printing press with a preferred embodiment of an inventive marking sensor;

FIG. 2 is a schematic depiction of the data inputs and outputs of a preferred embodiment of the inventive marking sensor; and

FIG. 3 is a schematic depiction of a control device with several preferred marking sensors.

### DESCRIPTION OF THE PREFERRED EMBODIMENTS

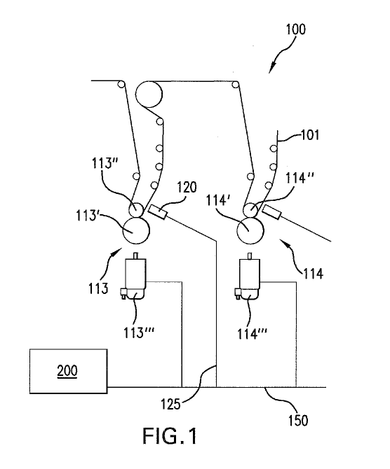

A printing press is shown schematically in sections in FIG. 1, and it is labeled with reference numeral 100. A processed material, e.g., paper, is supplied to the machine in the form of continuous material 101 via an infeed, which is not shown. It is understood that separate materials may also be processed. Paper 101 is then guided through several printing units, of which only printing units 113, 114 are shown, and they are printed on, then they are output via an outfeed, which is not shown. The infeed, outfeed, and printing units are located such that they may be positioned, in particular such that their cylinders or angles may be corrected.

Printing units 113, 114 include an impression cylinder 113′, 114′, against each of which a pressure roller 113″, 114″ is pressed with strong pressure. Impression cylinders 113′, 114′ may be driven separately and independently of each other. Associated drives 113′″, 114′″ are depicted schematically. The infeed and outfeed may also be driven separately via separate drives. The drives of the individual units are connected with a control device 200 via a data connection 150, which is preferably designed as an Ethernet connection.

A preferred embodiment of a marking sensor 120 is located between printing units 113 and 114, which is provided to detect markings on paper web 101. The markings (register marks) may be applied by upstream printing units, or they may be present on paper web 101 before it is processed. The marking sensor designed as register mark sensor 120 is also connected with control device 200, via its interface and using data connection 125. Data connection 125 is designed as an Ethernet connection.

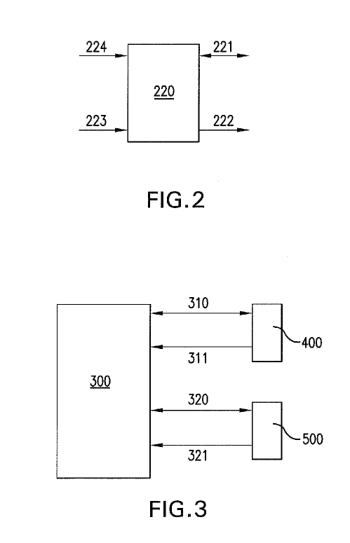

The functionality of a preferred embodiment of printing mark sensor 220 is referred to below with reference to FIG. 2. Marking sensor 220 includes an interface 221, which is designed as an Ethernet interface, for outputting and receiving data. The absolute marking data, in particular a marking distance and a marking width, are output via Ethernet interface 221. It is also possible via Ethernet interface 221 to configure sensor 220, so that it may automatically (without the manual “teach” process) measure markings and deliver measured values. It is also possible, via interface 221, to request diagnostic and oscilloscope data and to define their resolution. It is also possible to output error messages and/or statistics via interface 221.

Sensor 220 also includes a sensor input 223, which is suitable for use for connection with an input circuit for receiving the transport speed. The input circuit may be designed, e.g., to receive a TTL signal or an SSI (Synchronous Serial Interface) signal. As an alternative or in addition thereto, the sensor input may be able to frame markings on the printed image by producing—via the sensor input—an absolute reference of the markings to the actual sensor value, and—via a default angular range—by covering an angular window for the purposes of signal discrimination. In addition, sensor 220 includes a circuit output 222, which may be defined as a single output or a collective output. The circuit output is advantageously provided as a 24V signal. It is also possible, of course for the speed data to be transferred to sensor 220 via interface 221.

Sensor 220 also includes a circuit input 224 for receiving circuit data, in particular from a circuit output of a further sensor. As a result, the precondition is created, in particular, for carrying out the “top side/underside” method, with which a comparison of the front sides and back sides of register marks is carried out by coupling sensors. For example, a sensor measures the markings on the front side and outputs—via its circuit output—the signal of the detected marking to the sensor on the back side of the material web at its circuit input. This sensor may now calculate the distance between the markings on the front and back sides and reply via the interface.

The communication of the sensor via the interface with a higher-order control device, a higher-order automation system, or a higher-order drive may take place via several channels. Preferably, one communication channel is provided for acyclical communication, and one communication channel is provided for cyclical communication, i.e., at least two communication channels are provided.

The sensor is configured via the acyclical channel, with the sensor acting as the server. The sensor responds during communication only when it receives a telegram from the higher-order system. All configuration data are exchanged via this channel. The sensor confirms that the data received are valid. The acyclical channel is preferably driven via TCP/IP, with a connection being established and lost telegrams being resent. It is also possible, via the acyclical channel, to define and/or request the oscilloscope data, and to inquire about the diagnostic data.

During cyclical communication, the sensor functions as a client that transfers the absolute output data as soon as it has detected the necessary markings and has calculated their separation. The cyclical channel is preferably operated via UDP/IP. The control device checks the selected UDP port and receives the transmitted sensor data. As an alternative, a cyclical communication via TCP/IP is provided, in which case the sensor also serves a client function. The cyclical communication (via UDP/IP or TCP/IP) may also be provided with a server function of the sensor, in which case the higher-order system, e.g., the control device, inquires about the most recent sensor data that was acquired at suitable points in time, or in a cyclical manner (polling).

FIG. 3 is a schematic depiction of the design of a processing machine with the use of several inventive marking sensors. With the preferred embodiment shown, the marking sensors include Ethernet Interfaces, and the data transmission takes place using the TCP/IP protocol.

A control device 300 is connected with a marking sensor 400 and a marking sensor 500. The connection is designed as an Ethernet connection, in which case, for communication purposes, control device 300 with sensors 400 and 500, acyclical channels 310 and 320, and cyclical channels 311 and 321 are defined within the framework of the Ethernet connection. As described above, it is advantageous to provide TCP/IP connections for acyclical communication channels 310 and 320, in which case a separate TCP port is reserved within the control device for communication with every individual sensor 400, 500. The TCP port of the sensor may also be specifiable as desired, or it may be set up in a fixed manner.

As described above, UDP/IP connections are defined for cyclical communication channels 311 and 321, in which case a separate UDP port is also reserved by the control device for every sensor that is connected. With cyclical UDP communication, different ports for each sensor are also advantageously defined on the sensor side.

It is understood that only one particularly preferred embodiment of the present invention is depicted in the FIGURES shown. Any other type of embodiment is also feasible, without leaving the framework of the present invention.

It will be understood that each of the elements described above, or two or more together, may also find a useful application in other types of methods and constructions differing from the types described above.

While the invention has been illustrated and described as embodied in a marking sensor and method for evaluating markings, it is not intended to be limited to the details shown, since various modifications and structural changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

What is claimed as new and desired to be protected by Letters Patent is set forth in the appended claims:

1. A marking sensor, including a detection unit for detecting markings on a processed material and for acquiring data based on the detected markings; at least one circuit output for outputting the acquired data; an evaluation unit for determining absolute output data on the detected markings based on the data acquired by the detection unit; and an interface for outputting the absolute output data.

2. The marking sensor as defined in claim 1, wherein the interface is configured as an Ethernet interface.

3. The marking sensor as defined in claim, further comprising a sensor input for receiving data.

4. The marking sensor as defined in claim 1, further comprising at least one circuit output for outputting the acquired data as an output selected from the group consisting of a single output and a collective output.

5. The marking sensor as defined in claim 1, further comprising at least one circuit input for receiving circuit data.

6. The marking sensor as defined in claim 5, wherein the at least one circuit input is configured so that further absolute output data are determinable using the at least one circuit input.

7. The marking sensor as defined in claim 1, further comprising at least one input for connecting further detection units.

8. A method for evaluating markings, comprising the steps of detecting markings on a processed material by a detection unit; acquiring data by the detection unit based on the detected markings; transferring the acquired data to an evaluation unit in a marking sensor; determining absolute output data on the detected markings in the evaluation unit based on the data acquired by the detection unit; and outputting the absolute output data on the detected markings at an interface of the marking sensor.

9. The method for evaluating markings as defined in claim 8, further comprising outputting the data acquired by the detection unit based on the detected markings to at least one circuit surface.

10. The method for evaluating markings as defined in claim 8, further comprising carrying at least one web-measuring method in the marking sensor.

11. The method for evaluating markings as defined in claim 8, further comprising coupling at least two marking sensors, determining absolute output data by the evaluation unit of one of the at least two marking sensors, as a function of internal data and a coupling information.

12. The method for evaluating markings as defined in claim 11, further comprising carrying out the coupling information using a circuit output and a circuit input.

13. The method for evaluating markings as defined in claim 8, further comprising transferring a service-based protocol via the interface on a basis selected from the group consisting of a TCP basis, a UDP basis, and both, using a service discovery at a beginning of a telegram data field.

14. The method for evaluating markings as defined in claims 8, further comprising configuring the marking sensor via the interface (221).

15. The method for evaluating markings as defined in claim 14, wherein the configuring of the marking sensor via the interface includes using a protocol selected from the group consisting of a TCP/IP protocol, a UDP/IP protocol, and both.

16. The method for evaluating markings as defined in claim 14, further comprising including in the marking sensor a functionality selected from the group consisting of a server functionality and a client functionality, with regard for the configuration.

17. The method for evaluating markings as defined in claim 8, further comprising including in the marking sensor a functionality selected from the group consisting of a server functionality and a client functionality with regard for a cyclical data transmission of the output data.

18. The method for evaluating markings as defined in claim 8, further comprising outputting data selected from the group consisting of diagnostic data, oscilloscope data, and both at the interface of the marking sensor.

19. The method for evaluating markings as defined in claim 8, further comprising using the method in a printing press.

20. The method for evaluating markings as defined in claim 8, further comprising using the method in a printing press selected from the group consisting of a gravure press and a flexo printing press.

21. The method for evaluating markings as defined in claim 19, further comprising regulating a register selected from the group consisting of a longitudinal register, a lateral register, a cutting register and combinations thereof, using the marking sensor.

22. The method for evaluating markings as defined in claim 21, further comprising scanning a top side and an underside of a continuous material using at least two detection units.

23. A processing machine, comprising the marking sensor as defined in claim 1.

24. A processing machine as defined in claim 23, wherein the processing machine with the marking sensor as defined in claim 1 is a printing press.

25. A processing machine as defined in claim 24, wherein the printing press in which the marking sensor as defined in claim 1 is used is a press selected from the group consisting of a gravure press and a flexo printing press.
